(19) United States
(12) Patent Application Publication
(10) Pub. No.: US 2002/0022082 A1
(43) Pub. Date: Feb. 21, 2002

(54) Changing local compressibility of a wafer support member

(76) Inventor: Diane B. Scott, Portland, OR (US)

Correspondence Address: Rodel Holdings, Inc., Suite 1300, 1105 North Market Street, Wilmington, DE, 19899, US

(21) Appl. No.: 09/924,825

(22) Filed: Aug. 8, 2001

Related U.S. Application Data
(60) Provisional application No. 60/224,319, filed on Aug. 11, 2000.

(51) Int. Cl. B05D 5/12

(52) U.S. Cl. 427/96

(57) ABSTRACT

A wafer support member (1), and a method of changing local compressibility of a wafer support member (1) to provide a seal, includes, dispensing a curable sealant material (9) onto a resiliently compressible wafer support member (1), the support member having pores (6) for directing either fluid borne pressure or fluid borne vacuum between the wafer support member (1) and a backside of a wafer to be supported, wicking the sealant material (9) into pores (6) of the wafer support member (1), curing the sealant material (9) to provide a film closing each of the pores (6) that are intercepted by the sealant material (9), to change local compressibility of the edge margin (5) of the wafer support member (1), and provide a seal.

### CROSS REFERENCE TO RELATED APPLICATION

This application claims the benefit of provisional application No. 60/224,319 filed Aug. 11, 2000.

### FIELD OF THE INVENTION

The invention relates to a wafer support member for holding a wafer during polishing, and, more particularly, to a wafer support member for applying pressure or vacuum to a backside of a wafer, while a front surface of the wafer is urged against a moving polishing pad. The invention further relates to a method for changing local compressibility of the wafer support member.

### BACKGROUND OF THE INVENTION

According to U.S. Pat. No. 5,635,083, a semiconductor substrate, also known as a wafer, is placed face down against a moving polishing pad that polishes the face of the substrate to a planar surface. The substrate is forcibly pressed against the polishing pad with pneumatic or hydraulic pressure applied to the backside of the substrate during polishing.

Published European Application No. EP92118255, of EP 0539896, discloses a hard support member having an elastic member that holds a wafer during polishing of the wafer. The hard support member and the elastic member have finely sized through-holes through which a vacuum is drawn to hold the wafer against the elastic member by surface adhesion of the elastic member.

Apparatus for polishing a wafer is disclosed by published European Application No. EP96304118, of EP0747167, and includes, a polishing head having a wafer backing member with a recessed pocket that faces a wafer to be held by the wafer backing member. The pocket is surrounded by a projecting edge seal feature that engages the wafer at its perimeter. The pocket is pressurized with air or other fluid to provide a uniform force distribution pattern across the wafer to urge the wafer against a moving polishing pad. The force distribution pattern is contained by the edge seal feature on the backing member that engages the wafer at its perimeter. A frictional force between the seal feature and the perimeter of the wafer transfers rotational movement of the polishing head to the wafer.

A disadvantage of a wafer support member has resided in a need to form a recessed pocket in the wafer support member. The pocket is pressurized, which directs pressure forces in all directions, and diminishes the force that can be applied in a desired direction, that is orthogonally normal, against the wafer during polishing.

In the past, an edge seal has required an edge seal feature in the form of a structural member that has sufficient mass to resist the applied pressure, and that requires mechanical fastening to the wafer backing member.

### SUMMARY OF THE INVENTION

The invention eliminates a pocket in the wafer support member, and replaces a sealing member and a need for mechanically fastening a sealing member to the wafer support member. According to the invention, a wafer support member for holding a wafer during polishing is adapted for being either pressurized or drawn with a vacuum, to support the wafer. The wafer support member has finely divided pores extending therethrough to a planar platen surface on the wafer support member. The pores are directed to extend in a direction normal to the planar platen surface, and such direction extends orthogonally normal to a wafer backside on the wafer. Further, the pores are substantially noncommunicating with one another.

The pores are finely divided and evenly distributed, and direct fluid borne pressure, or fluid borne vacuum, through the pores, which substantially distributes the fluid evenly throughout the wafer support member, and evenly across the area of the wafer backside. Fluid flow is directed axially of the pores and normal to the wafer backside, which supports the wafer without deflection of the wafer from a precisely planar orientation, as the wafer is being held and while the wafer is urged toward a polishing pad by the planar platen surface on the wafer support member. According to an embodiment of the invention a perimeter seal along an edge margin of the wafer support member is in the form of a self-adherent, curable sealant material forming a film that bridges across the pores that are intercepted by the perimeter seal. The sealant material is applied by a printing process. The sealant material forms a perimeter seal that intercepts pores along a perimeter edge margin of the wafer support member, enabling the edge margin of the wafer support member to bear the perimeter seal against the backside of the wafer, and contain the fluid borne pressure or the fluid borne vacuum over a substantial area of the wafer backside.

The invention eliminates a pocket in the wafer support member, and replaces a sealing member and a need for mechanically fastening a sealing member to the wafer support member.

### DESCRIPTION OF THE DRAWINGS

Other objects and advantages of the invention are apparent by way of example from the following description of embodiments taken in conjunction with the accompanying drawings, according to which:

FIG. 1 is an isometric view of an embodiment of a wafer support member;

FIG. 2 is a fragmentary cross section, greatly enlarged, and exaggerated, of a wafer support member, as disclosed by FIG. 1;

FIG. 2A is a view similar to FIG. 2 of an embodiment of a projecting perimeter seal on a wafer support member;

FIG. 3 is an isometric view of another embodiment of a wafer support member having a perimeter edge seal combined with a topology conformance seal that conforms to an area of uneven topology of a wafer surface to be polished; and

FIG. 4 is an isometric view of a stencil for printing the perimeter edge seal onto a wafer support member.

### DETAILED DESCRIPTION OF THE INVENTION

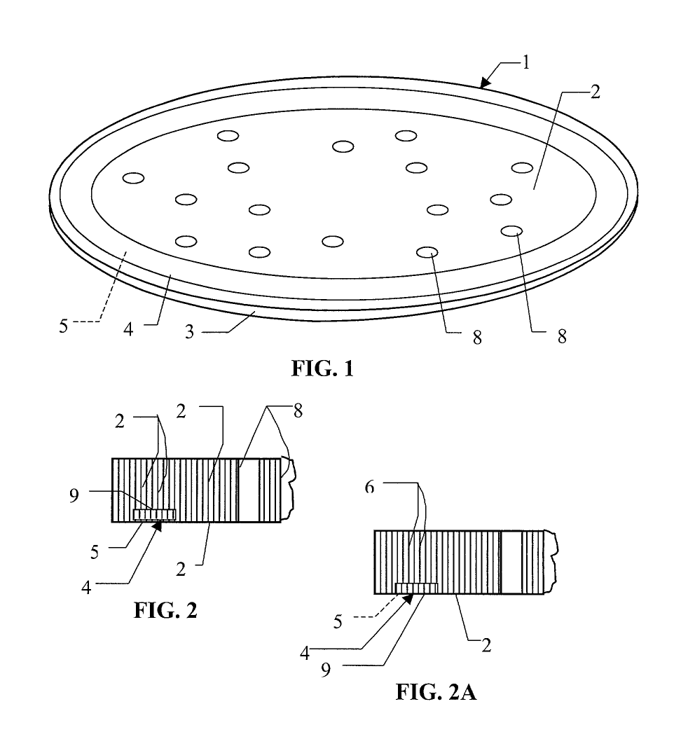

FIG. 1 discloses an embodiment of a wafer support member 1 having a substantially planar platen surface 2 with a circular edge 3. The planar platen surface 2 has a continuous perimeter seal 4 along an edge margin 5 adjacent to the circular edge 3. The planar platen surface 2 will face toward and cover a backside of a wafer, meaning a backside of either an unfinished, flat slice of silicon wafer to be polished or a silicon wafer on which is deposited a thin film having a surface topography to be polished. Polishing is performed by a known polishing apparatus. For example, a known chemical mechanical polishing apparatus, as disclosed by U.S. Pat. No. 5,635,083 has a carrier, or carrier head, for holding a silicon wafer having a thin film during polishing. A polishing apparatus variation, known as a template, has a carrier, or carrier head, for holding an unfinished, flat silicon wafer during polishing. The wafer support member 1 is secured to the carrier, or carrier head, of any of the known polishing systems.

FIG. 2 discloses the wafer support member 1 having finely divided pores 6 distributed evenly throughout. The pores 6 extend through the thickness of the wafer support member 1, through an adhesive back surface 7 on the wafer support member 1, and through the planar platen surface 2 on the wafer support member 1. The adhesive back surface 7 is provided to adhesively secure to a carrier, or carrier head, of a known polishing apparatus. The pores 6 extend axially in a direction orthogonally normal to the planar platen surface 2, and are thereby oriented to extend in a direction orthogonally normal to a backside of a wafer to be supported during polishing. Further, the pores 6 are substantially noncommunicating with one another.

The pores 6 finely divide and evenly distribute fluid borne pressure, or fluid borne vacuum. throughout the wafer support member 1, and across the surface area of the planar platen surface 2. The fluid borne pressure or fluid borne vacuum is finely divided and evenly distributed across an area of the wafer backside that is bounded by the perimeter seal 4. The fluid is contaminate free air or other gaseous atmosphere.

Deionized water may also be present to mix with the fluid. Multiple relief openings 8 through the thickness are provided, for example, to transport the deionized water for spreading over the planar platen surface 2 and over a wafer being supported by the wafer support member 1. Further, the openings 8 provide rapid transport of the fluid borne pressure or vacuum until the pressure or vacuum attains steady state equilibrium.

Finely divided and evenly distributed fluid flow is directed axially of the pores 6 and normal to the wafer backside, which supports the wafer without deflection of the wafer from a precisely planar orientation as the wafer is being supported by the planar platen surface 2, and while the wafer is urged toward a polishing pad by the planar platen surface 2. A desired planar polished surface on the wafer is attainable by having the wafer supported by the wafer support member 1 without deflection from a planar orientation. Further, the wafer is supported by the planar platen surface 2 without relative rotation.

The pores 6 are adapted for use with a fluid borne pressure. The fluid flows through the pores 6, which substantially distributes the fluid evenly throughout the wafer support member 1, and evenly across both the planar platen surface 2 and the area of the wafer backside. The pores 6 direct the fluid axially of the pores 6 and in a direction that is orthogonally normal to the wafer backside, which enables the wafer to be supported by the fluid borne pressure without deflection of the wafer from a precisely planar orientation for planar support against the planar platen surface 2 on the wafer support member 1.

Alternatively, the pores 6 are adapted for use with a fluid borne vacuum that flows through the pores 6, which substantially distributes the fluid evenly throughout the wafer support member 1, and evenly across both the planar platen surface 2 and the area of the wafer backside. The pores 6 direct the fluid axially of the pores 6 and in a direction that is orthogonally normal to the wafer surface, which enables the wafer to be drawn by vacuum without deflection of the wafer from a precisely planar orientation for planar support against the planar platen surface 2 on the wafer support member 1.

With reference to FIG. 2, according to an embodiment of the invention, the perimeter seal 4 along an edge margin 5 of the wafer support member 1 is in the form of a self-adherent, curable sealant material 9, for example, a room temperature curable, polyvinylchloride resin, commercially available and known by the associated trademark Plastisol. The sealant material 9 is of low viscosity, causing it to wick easily by capillary action into the pores 6 that are intercepted by the perimeter seal 4. When air cured, the sealant material 9 forms a film that bridges across each of the pores 6 that are intercepted by the sealant material 9 of the perimeter seal 4. The sealant material 9 is deposited or dispensed by printing, as further disclosed by FIG. 4. The wafer support member 1 is provided with the perimeter seal 4 to change the local compressibility of the support member in an area intercepted by the perimeter seal 4.

The sealant material 9 forms a perimeter seal 4 within the pores 6 that are intercepted by the sealant material 9 of the perimeter seal 4, closing the pores 6 that are along the perimeter edge margin 5 of the wafer support member 1. The fluid borne pressure that may be present in the pores 6 that are intercepted by the perimeter seal 4 will bear against the perimeter seal 4, and will be prevented by the perimeter seal 4 from being applied against the wafer backside. Alternatively, the fluid borne vacuum that may be present in the pores 6 that are intercepted by the perimeter seal 4 will be prevented by the perimeter seal 4 from being applied against the wafer backside.

For the embodiment disclosed by FIG. 2, the sealant material 9 is printed on the planar platen surface 2, and is wicked into the intercepted pores 6, without covering the edge margin 5 of the planar platen surface 2, enabling the edge margin 5 itself to be adapted to impinge against the backside of the wafer to form a seal, and to contain the fluid borne pressure or the fluid borne vacuum over a substantial area of the wafer backside that is bounded by the perimeter seal 4.

FIG. 2A discloses an embodiment of a projecting perimeter seal 4 that covers the edge margin 5 of the planar platen surface 2 on the wafer support member 1. The perimeter seal 4 is formed by dispensing the sealant material 9, similarly as described with reference to FIG. 2, and is thickened, for example, by repeated dispensing of the sealant material 9, so as to cover the edge margin 5 of the planar platen surface 2. The edge margin 5 of the planar platen surface 2 covered by the sealant material 9 is adapted to impinge against the wafer backside to form a seal and to contain the fluid borne pressure or the fluid borne vacuum over a substantial area of the wafer backside that is bounded by the perimeter seal 4.

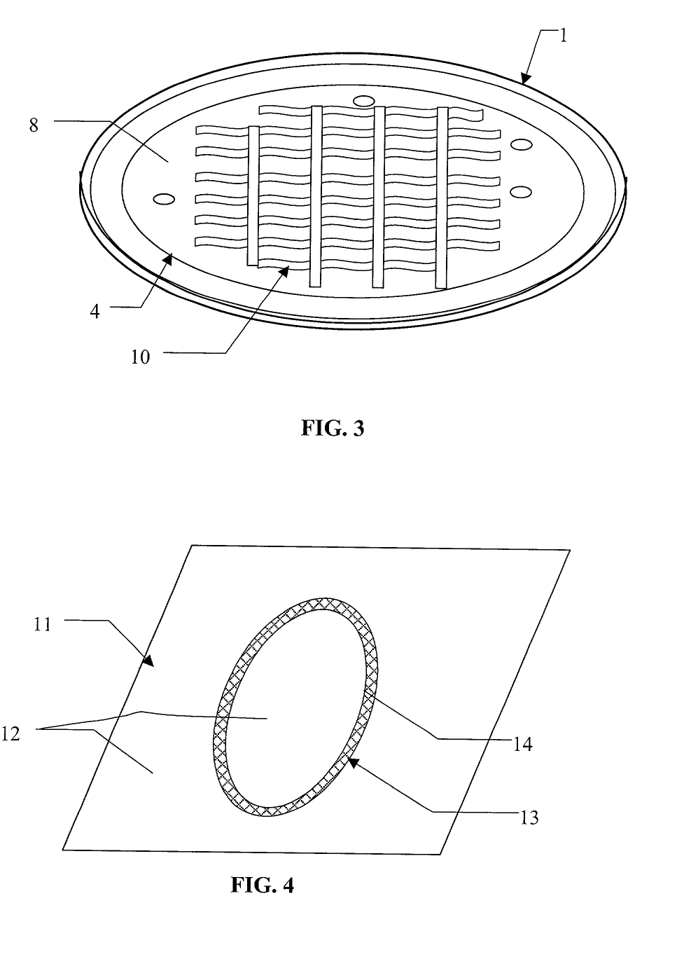

FIG. 3 discloses an embodiment of a wafer support member 1 adapted with a map of one or more than one, localized seal 10 formed by dispensing the curable sealant material 9 on the planar platen surface 2, and allowing the sealant material 9 to wick into each of the pores 6 that are intercepted by the localized seal 10. Upon curing, the sealant material 9 forms a film bridging across each of the pores 6 that are intercepted by the sealant material 9 of the localized seal 10. The sealant material 9 is printed on the planar platen surface 2, and is wicked into the intercepted pores 6, without covering the planar platen surface 2, enabling the uncovered planar platen surface 2 itself to be adapted to impinge against the backside of the wafer to form a localized seal 10. Alternatively, the localized seal 10 is thickened, for example, by repeated dispensing of the curable sealant material 9, so as to cover a portion of the planar platen surface 2. The covered portion of the planar platen surface 2 is adapted to impinge a wafer backside and provide a localized seal 10.

The localized seal 10 is provided to change local compressibility of the wafer support member 1 to compensate for localized differences in height of a wafer front surface to be polished. For example, a wafer front surface may have peaks and valleys, which require the peaks to be polished to a planar surface of desired height, with minimized polishing of the valleys. A map of the peaks and valleys is obtained, for example, by a conventional photomicrograph. Each localized seal 10 is oriented to follow the valleys, which leaves the wafer backside underlying the peaks subject to the above described, fluid borne pressure, such that the peaks are urged with greater pressure than are the valleys toward a polishing pad. Alternately, each localized seal 10 is oriented to follow the peaks, which leaves the wafer backside underlying the valleys subject to the above described, fluid borne vacuum, such that the valleys are subject to the fluid borne vacuum, and are urged by the fluid borne vacuum to counteract the localized pressure applied by a polishing pad against the valleys. The wafer support member 1 is provided with the perimeter seal 4 and the map of each localized seal 10 to change the local compressibility of the support member in an area intercepted by the perimeter seal 4 and in the area intercepted by the localized seal 10.

FIG. 4 discloses a stencil 11 having an opaque pattern 12 covering a taut screen 13. The opaque pattern has a patterned opening 14 that extends through the stencil 11, and overlies the taut screen 13 through which the curable sealant material 9 in a fluent state is dispensed to impinge upon the planar platen surface 2 of the wafer support member 1 that is located beneath the screen 13. The sealant material 9 is screen printed onto the planar platen surface 2 through the patterned opening 14 that corresponds to the shape of the perimeter seal 4. One or more than one additional patterned opening, not shown, is provided by the stencil 11 to correspond to the outline of the map of the localized seal 10. The sealant material 9 is dispensed, for example, by a painting brush or by a nozzle of an aerosol dispenser, or by a nozzle of an ink jet printer that is digitally programmed to follow each patterned opening through the stencil 11.

According to an embodiment, the wafer support member 1 is a resiliently compressible, porous urethane, 200 mm. in thickness, commercially available from Rodel, Inc., Newark, Del., USA, and known as DF 200. The openings 8 are formed by punching.

Although embodiments of the invention have been described, other embodiments and modifications are intended to be covered by the spirit and scope of the appended claims.

What is claimed is:

1. A wafer support member comprising: a substantially planar platen surface to face a wafer during polishing, the wafer support member having finely divided pores substantially distributing either fluid borne pressure or fluid borne vacuum evenly throughout the wafer support member and evenly across an area of a backside surface of the wafer, the pores directing the fluid axially of the pores and in a direction orthogonally normal to a wafer during polishing to support a substantial area of the wafer without deflection from a precisely planar orientation, and a perimeter seal along an edge margin of the wafer support member, the perimeter seal being formed by a sealant material that forms a film bridging across each of the pores that are intercepted by the perimeter seal.

2. The wafer support member as recited in claim 1 wherein, the edge margin is uncovered by the sealant material, and is adapted to contact a wafer during polishing to contain the fluid.

3. The wafer support member as recited in claim 1, and further comprising: the sealant material having been printed onto the planar platen surface and wicked into the pores.

4. The wafer support member as recited in claim 1 wherein, the edge margin is covered by the sealant material, and the sealant material covering the edge margin is adapted to contact a wafer during polishing to contain the fluid.

5. The wafer support member as recited in claim 4, and further comprising: the sealant material having been printed onto the planar platen surface.

6. The wafer support member as recited in claim 1, and further comprising: the sealant material having been printed onto the planar platen surface.

7. The wafer support member as recited in claim 1, and further comprising: the wafer support member being fabricated of resiliently compressible material, and the sealant material changing local compressibility of the edge margin of the wafer support member to provide the perimeter seal.

8. The wafer support member as recited in claim 1, and further comprising: an adhesive back surface on the wafer support member.

9. The wafer support member as recited in claim 1, and further comprising: one or more than one localized seal on the planar platen surface provided by the sealant material that forms a film bridging across each of the pores that are intercepted by each localized seal, and each localized seal compensates for localized differences in height of a wafer front surface to be polished.

10. The wafer support member as recited in claim 9 wherein, each localized seal is oriented to follow valleys in the topography of the wafer front surface.

11. The wafer support member as recited in claim 9 wherein, each localized seal is oriented to follow peaks in the topography of the wafer front surface.

12. A wafer support member comprising: a substantially planar platen surface to face a wafer during polishing, the wafer support member having finely divided pores substantially distributing either fluid borne pressure or fluid borne vacuum evenly throughout the wafer support member and evenly across an area of a backside surface of the wafer, the pores directing the fluid axially of the pores and in a direction orthogonally normal to a wafer during polishing to support a substantial area of the wafer without deflection from a precisely planar orientation, sealant material forming a perimeter seal along an edge margin of the wafer support member, the wafer support member being fabricated of resiliently compressible material, and the sealant material changing local compressibility of the edge margin of the wafer support member to provide the perimeter seal.

13. A method of changing local compressibility of a wafer support member to provide a seal, comprising the steps of:
dispensing a curable sealant material onto an edge margin of a resiliently compressible wafer support member, the support member having pores for directing either fluid borne pressure or fluid borne vacuum between the wafer support member and a backside of a wafer to be supported,
wicking the sealant material into pores of the wafer support member,
curing the sealant material to provide a film closing each of the pores along the edge margin that are intercepted by the sealant material, to change local compressibility of the edge margin of the wafer support member, and provide a perimeter seal along the edge margin and against the backside of the wafer to be supported.

14. The method as recited in claim 13, wherein the step of dispensing a curable sealant material further comprising the step of: printing the curable sealant material.

15. The method as recited in claim 13, wherein the step of printing the curable sealant material further comprises the step of screen printing the curable sealant material.

16. The method as recited in claim 13, wherein the step of printing the curable sealant material further comprises the step of ink jet printing the curable sealant material.

17. The method as recited in claim 13, and further including the step of: covering the edge margin with the sealant material to provide the perimeter seal.

18. The method as recited in claim 13, and further including the step of: closing the pores that intercept a localized area on the wafer support member with the sealant material to provide a localized seal.

19. The method as recited in claim 18, and further including the step of: orienting the localized seal is oriented to follow valleys in the topography of a front surface of the wafer to be polished.

20. The method as recited in claim 18, and further including the step of: orienting the localized seal is oriented to follow peaks in the topography of a front surface of the wafer to be polished.
